(19) United States
(12) Patent Application Publication
(10) Pub. No.: US 2026/0064725 A1
(43) Pub. Date: Mar. 5, 2026

(54) RESOURCE ANALYTICS SYSTEM

(71) Applicant: Oracle International Corporation, Redwood Shores, CA (US)

(72) Inventors: David Joseph Wannemacher, Bellevue, WA (US); Ivan Hernandez Serrano, Seattle, WA (US); Joshua Elliot Caplan, Seattle, WA (US); Imran Ali, Austin, TX (US); Hong Wu, Kirkland, WA (US); Igor Vasilev, Ottawa (CA)

(73) Assignee: Oracle International Corporation, Redwood Shores, CA (US)

(21) Appl. No.: 19/319,409

(22) Filed: Sep. 4, 2025

Related U.S. Application Data
(60) Provisional application No. 63/690,992, filed on Sep. 5, 2024.
(60) Provisional application No. 63/712,304, filed on Oct. 25, 2024.

(51) Int. Cl. G06F 16/28; G06F 16/21; G06F 16/22; G06F 16/248

(52) U.S. Cl. CPC G06F 16/288; G06F 16/213; G06F 16/2282; G06F 16/248

(57) ABSTRACT

A resource analytics system (RAS) is disclosed that creates a single, centralized, and trusted source of cloud resource inventory that provides near real-time visibility for a user into cloud resources deployed across different geographical regions within a cloud environment. The RAS obtains resource metadata related to a set of resources deployed in a cloud environment and provides the resource metadata in a source relational data model. The RAS extracts user-specific resource metadata from the source relational data model and populates a target relational data model with the user-specific resource metadata. The target relational data model is created in a user tenancy associated with a user. The RAS receives a request to query the user-specific resource metadata in the target relational data model and obtains a query result related to execution of the query. The RAS causes display of the query result via one or more user interfaces.

### CROSS-REFERENCES TO RELATED APPLICATIONS

This application is a non-provisional application of and claims the benefit and priority under 35 U.S.C. 119 (e) of U.S. Provisional Application No. 63/690,992, filed Sep. 5, 2024, entitled “Resource Analytics System and Service,” and U.S. Provisional Application No. 63/712,304, filed Oct. 25, 2024 entitled “Resource Analytics System and Service,” the entire contents of which are incorporated herein by reference for all purposes.

### BACKGROUND

The demand for cloud-based services continues to increase rapidly. The term cloud service is generally used to refer to a service that is made available to users or customers on demand (e.g., via a subscription model) using systems and infrastructure (cloud infrastructure) provided by a cloud services provider. Typically, the servers and systems that make up the cloud service provider's infrastructure are separate from the customer's own on-premise servers and systems. Customers can thus avail themselves of cloud services provided by a cloud service provider without having to purchase separate hardware and software resources for the services. There are various different types of cloud services including Software-as-a-Service (SaaS), Platform-as-a-Service (PaaS), Infrastructure-as-a-Service (IaaS), and others. A customer can subscribe to one or more cloud services provided by a cloud service provider (CSP). The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

An ever increasing number of a customer's resources are now stored or provided by a CSP. These cloud resources are often spread across multiple tenancies and regions within a CSP making it challenging for customers to effectively interact with, view, manage, and track their cloud resource inventories. In certain approaches, a customer can use standardized query language tools (e.g., Resource Query Language (RQL)) or Application Programming Interfaces (APIs) to fetch and view relevant information related to their cloud resources based on specific criteria. However, these approaches suffer from certain drawbacks. For instance, in certain situations, a customer may wish to fetch and view relevant information related to cloud resources that may be spread across different tenancies and regions in a CSP. To obtain such information, a customer may need to crawl through several APIs to understand how these resources are organized and related across the different tenancies and regions and then collate the results from the individual API calls to obtain a final result. Given the vastness of cloud regions where data centers and infrastructure resources are established today, this can become a challenging and time consuming process for a customer. There is thus a need for developing more efficient cloud resource management solutions that what is possible by existing techniques.

### BRIEF SUMMARY

The present disclosure relates generally to cloud resource inventory management and more particularly to a resource analytics system (RAS) that includes capabilities for creating a single, centralized, and trusted source of cloud resource inventory that provides near real-time visibility for a user into cloud resources deployed across different geographical regions within a cloud environment.

In certain embodiments, a resource analytics system (RAS) is described. The RAS is configured to obtain resource metadata related to a set of resources deployed in a cloud environment and provide the resource metadata related to the set of resources in a source data model. The RAS then extracts user-specific resource metadata from the source data model and populates a target data model with the user-specific resource metadata. In certain examples, the source data model and/or the target data model may be implemented as relational data models. The target relational data model is created in a user tenancy associated with a user. In certain examples, the RAS receives a request to query the user-specific resource metadata in the target relational data model and obtains a query result related to execution of the query. In certain examples, the RAS causes display of the query result related to execution of the query via a user interface of the RAS.

In certain examples, the source relational data model comprises multiple sets of tables. A first set of tables in the multiple sets of tables comprises resource metadata related to a first set of resources from the set of resources. The first set of resources are associated with a first cloud service in a set of cloud services identified in a region of the cloud environment. In certain examples, a second set of tables in the multiple sets of tables comprises resource metadata related to a second set of resources from the set of resources. The second set of resources are associated with a second cloud service in the set of cloud services identified in the region of the cloud environment. In certain examples, the first cloud service is different from the second cloud service.

In certain examples, the target relational data model comprises multiple sets of tables and populating the target relational data model with the user-specific resource metadata comprises merging the user-specific resource metadata into one or more tables in the multiple sets of tables in the target relational data model.

In certain examples, storing the resource metadata related to the set of resources in the source relational data model comprises identifying a set of cloud services associated with the set of resources in a region of the cloud environment, identifying a set of resource types managed by each cloud service and obtaining cloud resource metadata associated with the set of resource types managed by the cloud service.

In certain examples, storing the resource metadata related to the set of resources in the source relational data model further comprises obtaining a schema associated with each cloud service, obtaining, a set of schema transformation rules associated with each cloud service and populating the source relational data model with the cloud resource metadata associated with the set of resource types managed by the set of cloud services based on the schema associated with each cloud service and the set of schema transformation rules associated with each cloud service.

In certain examples, the set of schema transformation rules comprise mapping information for mapping one or more attributes in the schema associated with each cloud service to corresponding columns in one or more tables in the source relational data model.

In certain examples, populating the target relational data model with the user-specific resource metadata comprises merging the user-specific resource metadata for the user into one or more tables in a set of tables in the target relational data model.

In certain examples, the RAS is configured to receive a request to create a new instance of a cloud resource inventory for the user in the user tenancy and provision the new instance of the cloud resource inventory in the user tenancy. In certain implementations, provisioning the new instance of the cloud resource inventory in the user tenancy further comprises creating the target relational data model in the user tenancy.

In certain examples, provisioning the new instance of the cloud resource inventory comprises provisioning an analytics and visualization model in the user tenancy. In certain examples, the analytics and visualization model is accessible to the user via the user interface of the resource analytics system.

In certain examples, a first interface element in the user interface enables the user to submit the query and view the query result related to execution of the query and a second interface element in the user interface enables the user to view one or more relationships between resource metadata associated with resources in the target relational data model via one or more resource graphs.

In certain examples, the resource metadata related to the set of resources deployed across the region in the cloud environment is obtained in near real-time.

In certain examples, the RAS is configured to obtain user input that identifies user-specific data associated with the user and ingest the user input into a set of tables in the target relational data model. In certain implementations, the user data resides in a networked computing environment that is outside the user tenancy in which the target relational data model is created for the user.

In certain examples, the RAS receives a second request to query the user-specific cloud resource metadata stored in the target relational data model in conjunction with the user data ingested into the set of tables in the target relational data model. Responsive to receiving the query, the RAS merges the user-specific cloud resource metadata and the user data to obtain a result related to execution of the second request and causes display of the result related to execution of the second request via the user interface of the RAS.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided therein.

### BRIEF DESCRIPTION OF THE DRAWINGS

FIG. 1 is a block diagram of an example computing environment including a resource analytics system that includes capabilities for providing near real-time visibility into a user's cloud resources deployed in a cloud environment, according to examples described herein.

FIG. 2 is a block diagram illustrating in greater detail an example of a centralized resource inventory management in the resource analytics system depicted in FIG. 1, according to certain embodiments.

FIG. 3 is a flowchart illustrating an example process used by the centralized resource inventory management subsystem in the resource analytics system for creating a single, centralized, and trusted cloud resource inventory of cloud resources, according to certain examples.

FIG. 4 is a flowchart illustrating an example process used by the centralized resource inventory management subsystem for populating a centralized resource inventory that is configured to store cloud resource metadata related to cloud resources, according to some examples.

FIG. 5 is a flowchart illustrating an example process used by the resource analytics system described in FIG. 1 for creating a user-specific cloud resource inventory for a user, according to certain examples.

FIG. 6 is a flowchart illustrating an example process used by resource analytics system shown in FIG. 1 for providing near-real time visibility into users' cloud resources that may be deployed and actively running across different geographical areas (regions) within a cloud environment, according to certain examples.

FIG. 7 illustrates an example of interactions between one or more data components in the RAS to provide near real-time cloud resource metadata related to cloud resources deployed across different tenancies and regions in a cloud environment, according to certain examples.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to cloud resource inventory management and more particularly to a resource analytics system (RAS) that includes capabilities for creating a single, centralized, and trusted source of cloud resource inventory that provides near real-time visibility for a user into cloud resources deployed across different geographical regions within a cloud environment.

As described in the background section, current approaches for performing cloud resource inventory management do not provide a uniform and flexible approach to view, manage and track cloud resource inventory across different tenancies and regions in a CSP. For instance, a customer who subscribes to cloud services provided by a CSP may wish to obtain information related to the customer's resources that may be spread across tenancies and regions of the CSP such as “Do I have any internet-facing compute instances with unencrypted storage volumes, in any cloud region,?” “Which resources have Virtual Network Interface Cards (VNICs) on this subnet that I would like to delete?”, “Rank my 50 production cloud tenancies in descending order of cost per month, grouped by region” and so on. To answer the above questions accurately, a customer currently has to crawl through various resource APIs to understand how these resources are organized and related across the multiple regions and tenancies within a CSP Infrastructure (CSPI). The customer then has to retrieve information related to potentially dozens of resource types using the APIs, across each tenancy and region, and thereafter manually collate the results from these individual APIs to obtain a final result. Given the vastness of regions in which cloud resource infrastructure is managed today and the complexity of relationships between resources across different tenancies and regions within a CSPI, in certain situations, a customer may additionally have to join data across multiple separate data sets (via multiple API calls across different tenancies and regions) one at a time to obtain a final query result. This can be a very time consuming and challenging process.

Additionally, if a user has to crawl through multiple APIs themselves they may run into API limits and be unable to generate a desired view of their cloud resource inventory and cloud resource relationships. Additionally, the user might even have to sacrifice the freshness of their cloud resource inventory data. Even if users can “consume” their API limits to build their cloud resource inventory, it may affect other (potentially production, business-critical) usage of the APIs. By providing users with a separate single, trusted source of resource inventory data, the disclosed technique provides its users with a near real-time view of their cloud resource inventory without having to impact the usage of their APIs. This also provides benefits to the cloud service provider, who in turn may not need to provision a large number of hardware resources to serve requests from users who wish to build their own cloud resource inventories.

The present disclosure describes techniques to simplify cloud resource management by providing customers with near real-time visibility into their cloud resource inventory deployed across multiple tenancies and regions of a cloud environment. The disclosed cloud resource inventory management technique eliminates the need for a customer to manually gather data through individual API calls, by creating a single, trusted source of resource inventory data. The single, trusted source of inventory data provides the customer with enhanced and near real-time visibility into the customer's resource infrastructure and resource relationships through a relational data model that the customer is able easily query in near-real time. For instance, using the techniques described herein, a customer need only submit a single query to the relational data model to obtain a query result. The disclosed technique provides the customer with a seamless and consistent single pane of view of their cloud resources in near real-time and dramatically reduces the computational and resource overhead of calling multiple APIs to obtain relevant information.

In certain embodiments, a Resource Analytics System (RAS) is described. The RAS system uses a novel architecture that streamlines cloud resource management for a user (sometimes referred to herein as a customer) by creating and maintaining an up-to-date and near real-time inventory of the user's cloud resource inventory (i.e., hardware and software resources, attributes, relationships, and resource configuration history) that may be deployed across different regions and tenancies of a CSP infrastructure (CSPI). The cloud resource inventory provides the user with a single, centralized, and trusted source for cloud resource inventory metadata that is consolidated cross different tenancies and regions and which is available on demand, and in near real-time (within minutes) to the user. The cloud resource inventory provides the user with enhanced visibility across the user's resource infrastructure and resource relationships through a relational data model that can be easily queried by the user in near-real time.

In certain examples, the RAS described herein provides the user with the ability to view relationships and connections between cloud resources stored in their cloud resource inventory. The relationships and connections between the cloud resources can further be displayed via one or more user interfaces implemented by the RAS and these resource connections can be provided to other components of the RAS or to external applications or services and used by the RAS for subsequent analysis. The relationships and connections between the cloud resources provide the customer with a comprehensive and centralized view of cloud resources across regions, tenancies, and compartments in the CSPI.

In certain embodiments, the RAS described in this present disclosure additionally provides a user with the ability to ingest their own user data 132 (customer-specific data) into their could resource inventories. The user data, for example, can reside in external applications or services, in a corporate network, an on-premises network, or other networked computing environment (other cloud networks) with which the user is associated with that is separate from the CSPI. The RAS additionally provides capabilities by which the user can define new relationships and issue queries that can join data between the user's cloud resources stored in their cloud resource inventory and the user-specific data and visualize these combined resource relationships via one or more user interfaces provided by the RAS.

### System Overview

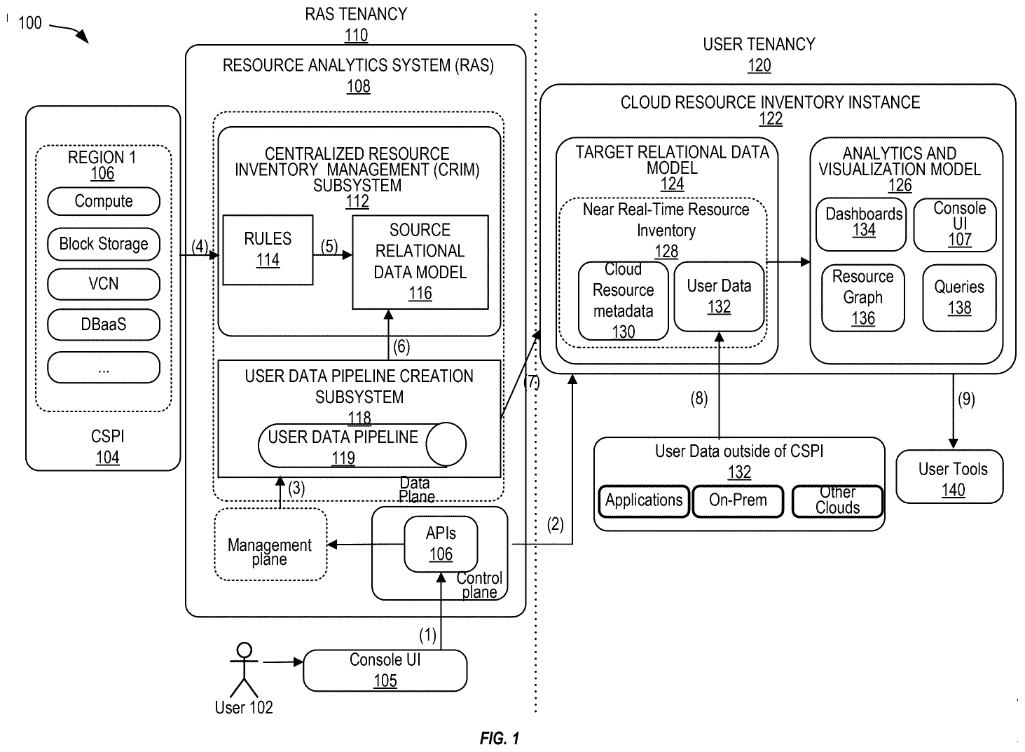

FIG. 1 is a block diagram of an example computing environment 100 including a resource analytics system (RAS) that includes capabilities for providing near real-time visibility into a user's cloud resources deployed in a cloud environment, according to examples described herein. The RAS 108 can be implemented in software only, hardware only, or a combination of hardware and software. For example, as shown in FIG. 1, the RAS 108 comprises software components executed by one or more electronic computing devices. The components of the RAS 108 may include, for instance, a centralized resource inventory management (CRIM) subsystem and user data pipeline creation subsystem 118. The RAS 108 depicted in FIG. 1 is merely an example of an arrangement of components in a model deployment system. One of ordinary skill in the art would recognize many possible variations, alternatives, and modifications. For example, in some implementations, the RAS 108 may have more or fewer systems or components than those shown in FIG. 1, may combine two or more subsystems, or may have a different configuration or arrangement of subsystems.

In certain examples, the components of the RAS 108 may be provided by a cloud provider network (e.g., as part of a shared computing resource environment). In other examples, the components of the RAS 108 may execute on computing devices managed within an on-premises datacenter or other computing environment such as in a RAS tenancy 110, or on computing devices located within a combination of cloud-based and on-premises computing environments. For instance, users of an enterprise may utilize the functionality of the RAS 108 to obtain and query a near real-time view of their cloud resource inventory metadata that is deployed in a cloud environment. In some other embodiments, the RAS 108 may be implemented on one or more servers of a cloud service provider (CSP) and its cloud resource management functionality may be provided to subscribers (e.g., an organization or an enterprise) who subscribe to cloud services on a subscription basis.

According to examples described herein, the RAS 108 includes capabilities to perform efficient cloud resource management by creating a single, centralized, and trusted source of cloud resource inventory metadata that provides near-real time visibility into users' cloud resources that may be deployed and actively running across different geographical areas (regions) within a cloud environment. Regions within a cloud environment that may be managed by a CSP may generally be independent of each other and separated by vast distances, such as across countries or even continents. For instance, examples of regions in a CSP may include US West, US East, Australia East, Australia Southeast, and the like.

In certain examples, the single, centralized, and trusted source of cloud resource inventory is created by the RAS 108 by ingesting, transforming, and synchronizing cloud resource metadata that may be deployed and actively running for all its users across different geographical areas (regions) of a CSP infrastructure (CSPI). The RAS 108 additionally includes capabilities to create user-specific cloud resource inventories to provide its users with near real-time visibility into their cloud resources (e.g., virtual machines, databases, storage buckets and so on) that are deployed and actively running across different geographical areas (regions) of the CSPI. The user-specific cloud resource inventories are created and provisioned in tenancies in the computing environment 100 with which the users are associated. As described in more detail hereinafter, users can view, explore, retrieve information and issue queries against their cloud resource metadata from these user-specific cloud resource inventories. Although only one user (sometimes also referred to herein as a customer) is depicted in the example of FIG. 1, in general, any number of users can concurrently interact with the RAS to perform the operations described herein.

In FIG. 1, the numbered steps labeled “1”-“9” illustrate a high-level process used by the RAS 108 to create a cloud resource inventory for a user (i.e., a user-specific cloud resource inventory) that provides the user with near real-time visibility into the user's cloud resources that may be deployed and actively running across different tenancies and geographical regions of a CSPI. While the numbers are sequential, in practice, the steps can be performed in any order and/or in parallel with one another. Additionally, while the steps “1”-“9” illustrate a high-level process used by the RAS 108 for creating a single user-specific cloud resource inventory, in general, the high-level process described in steps “1”-“9” may be used to concurrently create any number of user-specific cloud resource inventories for any number of users of the RAS 108.

According to examples described herein, as shown in FIG. 1, in step (1) a user 102 of the RAS 108 can create a new instance of a cloud resource inventory 110 (also referred to herein as a resource analytics (RA) instance) in a tenancy (e.g., a user tenancy 120) for which the user 102 is responsible for using a web-based console or other interface 104 provided by the RAS 108. The user tenancy 120 (also referred to herein as the user's reporting tenancy) may be separate from other tenancies within the CSPI 104 from where the user can ingest their cloud resources. The user tenancy 120 can include any number of computing resources operating as part of a corporate network or other networked computing environment with which the user is associated. Although the user tenancy 120 is shown as separate from the CSPI 104 in FIG. 1, more generally, the user tenancy 120 can include components hosted in an on-premises network, in the CSPI 104, or combinations of both (for example, as a hybrid cloud network).

In certain examples, the user 102 can initiate the creation of a new instance of a cloud resource inventory 122 using one or more APIs 106 provided by the RAS 108. The APIs 106 may be provided by a control plane component within the RAS 108. The user may, for instance, access the APIs 106 via an application or a web interface (e.g., a console UI 105), a Software Development Kit (SDK), or a command line interface of the user's computing device. To create a new instance of a cloud resource inventory 122, the user may specify, via the API, the user's reporting tenancy (i.e., user tenancy 120) and a region where the user wishes to create and provision the new instance of the cloud resource inventory and a list of monitored tenancies and regions (i.e., a list of tenancies and regions in the CSPI where the user's resources are deployed and actively running) in the CSPI to ingest their cloud resource inventory. The user 102 of the RAS 108 can create multiple instances of a cloud resource inventory and configure these multiple instances for any number of regions in the CSPI with which the user is associated, including regions that overlap. As described in more detail hereinafter, the new instance of the cloud resource inventory instance 122 provides the user 102 with a near real-time visibility into the user's resources that are deployed across different tenancies and regions within the CSPI. The user can further utilize the new instance of the cloud resource inventory 122 to view, explore and retrieve their cloud resource inventory metadata and to also issue queries against their cloud resource metadata.

After the user submits a request to the RAS 108 to create a new instance of a cloud resource inventory 122, at step (2), the RAS 108 provisions the new instance of the cloud resource inventory 122 (sometimes also referred to herein as a Resource Analytics (RA) instance) in the user tenancy (e.g., 120) specified by the user. In certain examples, provisioning a new instance of the cloud resource inventory 122 involves provisioning, by the RAS 108, one or more underlying resources associated with the new instance of the cloud resource inventory 122. The underlying resources that may be provisioned as part of a new cloud resource inventory instance may include (1) a target relational data model 124 (also referred to herein as an autonomous data warehouse (ADW) resource) and (2) an analytics and visualization (AV) model 126. In certain implementations, the target relational data model (e.g., 124) may be implemented as a relational database comprising a set of tables. The tables in the target relational data model 124 may be configured to store near real-time resource metadata related to cloud resources (e.g., virtual machines, databases, storage buckets and so on) that are deployed and actively running across the list of monitored regions in the CSPI specified by the user. The AV model 126 enables the user to connect to the target relational data model to visualize user-specific near real-time resource metadata related to cloud resources. Additional details related to different interactions that can be performed by the user using the target relational data model and the AV model to view information related to the user's cloud resource metadata are described hereinafter.

In certain implementations, in addition to orchestrating the creation of a new RA instance at step (2) for the user 102 in the user tenancy 120, the RAS 108 also triggers the provisioning of a new instance of a user data pipeline 119 for the user. The creation of the new instance of the user data pipeline 119 may be initiated by the control plane component in the RAS 108 by transmitting a request (e.g., via an API call) to a management plane component in the RAS 108. The management plane component then routes the request in step (3) to a data pipeline creation subsystem 118 in the RAS 108 to provision the new instance of a user data pipeline (e.g., 119) for the user. In certain implementations, and as will be described in more detail hereinafter, the new instance of the user data pipeline may be implemented by data plane components within the RAS 108. The new instance of the user data pipeline acts as an intermediary entity for extracting user-specific cloud resource metadata, in near real-time, from a centralized resource inventory management (CRIM) subsystem in the RAS 108 and merging the extracted user-specific cloud resource metadata into the new instance of the cloud resource inventory 122 created and provisioned for the user in the user tenancy.

Accordingly, in some examples, upon provisioning the new instance of the cloud resource inventory 122, its underlying resources (e.g., 124, 126) and the new instance of the user data pipeline 119 as described above, at step (4), a centralized resource inventory management (CRIM) subsystem 112 within the RAS 108 ingests, in near real-time, cloud resource metadata related to cloud resources for all its users that may be spread across multiple tenancies and regions managed by the CSPI 104. In certain examples, a region (e.g., 106) managed by the CSPI may maintain a comprehensive list of all the cloud resources (e.g., virtual machines, databases, storage buckets and so on) that are deployed and actively running for all its users across one or more tenancies within the region. A tenancy (i.e., an account) may refer to a logical, isolated partition within a cloud region where a user can create, organize, and manage their cloud resources. A tenancy provides a secure space for the user's applications and data within the region.

In certain examples, the cloud resources within a region (e.g., 106) may be managed by different cloud services within the CSPI. Each cloud service may be responsible for providing a single, trusted source for cloud resource metadata related to cloud resources managed by the cloud service. For instance, the cloud resources in region 106 may be managed by a set of cloud services that may include compute services, block storage services, Virtual Cloud Network (VCN) services, database services (DBaaS) and so on. Although only one region is depicted in the example of FIG. 1, in general, the RAS 108 may be configured to concurrently obtain cloud resource metadata from any number of cloud regions and from any number of services managed by the CSPI.

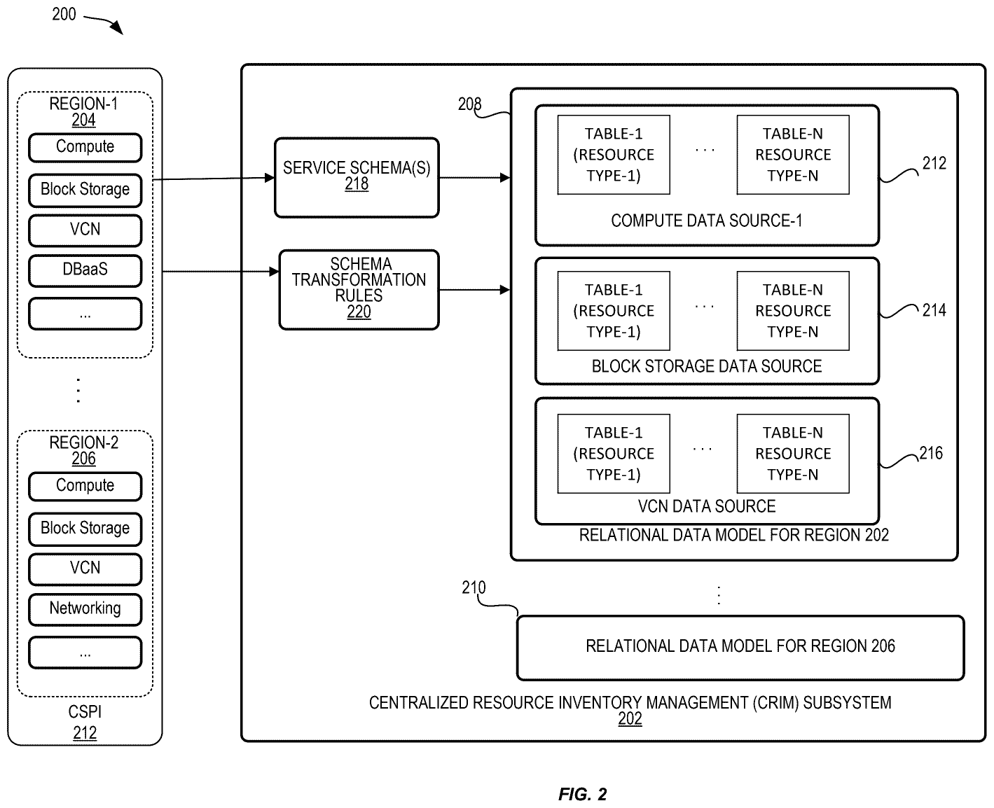

At step (5), the CRIM subsystem 112 populates a source relational data model 116 with cloud resource metadata associated with the set of cloud services. In certain examples, the source relational data model 116 may be implemented in the CRIM subsystem 112 as a relational database. The source relational data model 116 provides a snapshot of near real-time cloud resource metadata related to cloud resources deployed in the CSPI for all its users across different tenancies and regions within the CSPI. In certain examples, and as will be described in more detail hereinafter, the CRIM subsystem 112 may additionally utilize a set of schema transformation rules 114 to transform and synchronize the cloud resource metadata related to all its users into a structure and format of the source relational data model. Details related to the operations performed by the RAS to create and populate a source relational data model 116 with cloud resource metadata associated with a set of cloud services deployed in a cloud environment is described in FIGS. 2-4 below.

At step (6), the RAS 108 bootstraps the new instance of the user data pipeline 119 that was created by the user data pipeline subsystem 118 as part of the provisioning process described above. The new instance of the user data pipeline 119 acts as an intermediary entity that is used by the RAS for extracting user-specific cloud resource metadata from the source relational data model 116 and transforming (i.e., modifying) the user-specific cloud resource data to fit the data into a specific format or structure of a target relational data model (e.g., 124) that is created as part of the new instance of the cloud resource inventory 122 in the user tenancy 120.

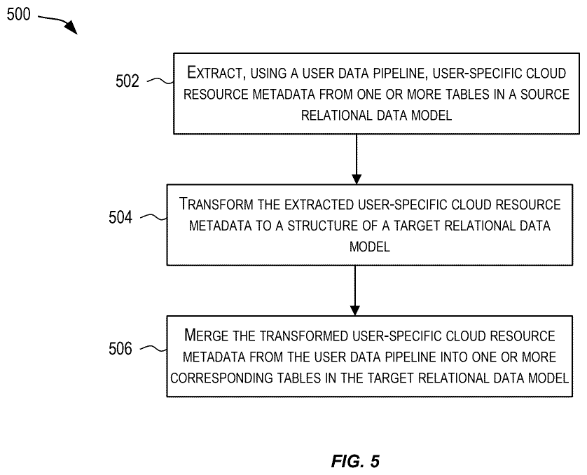

At step (7), the user data pipeline creation subsystem 118 merges the user-specific cloud resource data stored in the new instance of the user data pipeline 119 into the specific format or structure of the target relational data model 124. Once the target relational data model 124 is populated with user-specific cloud resource metadata, a user 102 of the RAS 108 can connect to the new instance of the cloud resource inventory 122 (also referred to herein as a user-specific cloud resource inventory) provisioned in the user's tenancy 120 via the console UI 104 to obtain an up-to-date and near real-time view of the user's cloud resource inventory (i.e., hardware and software resources, attributes, relationships, and resource configuration history) across the different regions and tenancies within a CSPI. Additional details related to the operations performed by the RAS to create a user-specific cloud resource inventory for a user is described in FIG. 5.

In certain embodiments, the user 102 can connect to the AV model 126 that is provisioned as part of the new instance of the cloud resource inventory 122 via the console UI 105 to issue queries 138 against their cloud resource metadata 130 stored as part of the user's near real-time resource inventory 128 in the target relational data model 124. For instance, the user can connect to the AV model 126 and submit a single query such as “Find all running instances across all regions in the CSPI that have a public Internet Protocol (IP) address and unencrypted storage volumes” to view specific information related to their cloud resource metadata deployed across different regions and tenancies within the CSPI. In certain examples, the user 102 may view the query result via the console UI 105 using built-in dashboards and reports 134 provided by the AV model 126. The AV model 126 may additionally be configured to provide the user with a user interface (UI) for creating, querying, analyzing, and visualizing resource graphs 136. The resource graphs 136 can be used by the user to view relationships and connections between cloud resources and provide the user with a comprehensive and centralized view of the user's cloud resources across regions, tenancies, and compartments associated with the user in the CSPI.

As previously described, existing approaches for performing cloud resource inventory management typically involve a user having to crawl through various resource APIs to query and retrieve information about potentially dozens of resource types, across each tenancy and region, and then manually collate the results. Given the vastness of regions in which cloud resource infrastructure is managed today and the complexity of relationships between resources across different tenancies and regions within a CSPI, calling multiple APIs repeatedly to obtain a result can be a very time consuming and challenging process. The RAS 108 described in this present disclosure provides advancements and improvements over existing approaches for performing cloud resource inventory management. For instance, using the techniques described herein, for the example described above, a user can submit a single query such as “Find all running instances across all regions that have a public IP address and unencrypted storage volumes” to the target relational data model and obtain a query result. The user does not repeatedly have call multiple APIs to join data across multiple separate data sets (via multiple API calls across different compartments and regions) one at a time to obtain a result. In certain implementations, the query may be constructed by the user using the Structured Query Language (SQL). An example of an SQL query that may be submitted by the user of the RAS described herein is shown in Example-1 below.

### Example-1

| | |
|---|---|
| SELECT | -- Select desired projection columns. |

| | |
|---|---|
| t1.id | AS instance_id, |
| t1.displayName | AS instance_name, |
| t3.id | AS vnic_id, |
| t3.ip | AS vnic_ip, |
| t5.id | AS volume_id, |
| t5.sizeGB. | AS volume_size_gb, |
| t5.isEncrypted | AS volume_encrypted |

| | |
|---|---|
| FROM Instances AS t1 | -- Start with the instances table. |
| JOIN InstanceVnicAttachments AS t2 ON TRUE | -- Join with instance vnic attachments to find vnics. |

AND t1.id = t2.instanceId

| | |
|---|---|
| JOIN Vnics AS t3 ON TRUE | -- Join with the vnic table to find Vnics with non-private IP's. |

AND t3.id = t2.vnicId

| | |
|---|---|
| JOIN InstanceVolumeAttachments AS t4 ON TRUE | -- Join with volume attachments to find volumes. |

AND t1.id = t4.instanceId

| | |
|---|---|
| JOIN Volumes AS t5 ON TRUE | -- Join with volumes to find unencrypted volumes. |

AND t5.id = t4.volumeId

| | |
|---|---|
| WHERE TRUE | -- Filters go here. |

```
  AND t3.ip NOT LIKE ‘10.%’
  AND NOT t4.isEncrypted
  AND t1.state = ‘RUNNING’
```

In certain implementations, at step (8), the RAS 108 described in this present disclosure additionally provides the user with the ability to ingest their own “user data” 132 (sometimes referred to herein as customer data) into the could resource inventory instance 122 created in the user tenancy. The user data, for example, can reside in external applications or services, in a corporate network, an on-premises network, or other networked computing environment (other cloud networks) with which the user is associated with that is separate from the CSPI 104. In certain embodiments, the user data 132 may be ingested by the RAS 108 into separate tables within the target relational data model 124. The user can then issue queries that can that join across the user's cloud resource metadata 130 and the user's application-specific metadata 132. The user can additionally define new relationships within the target relational data model 124 (using join columns) between their customer data 132 and their cloud resource data 130 and visualize these combined resource relationships via the console UI. In certain embodiments, at step (9) this information can further be displayed in one or more user interfaces via the console UI, provided to other components of the RAS 108 or to external applications or services or user tools 140, used for subsequent analysis processes, and the like.

### Creation of a Centralized Resource Inventory

FIG. 2 is a block diagram illustrating in greater detail an example of a centralized resource inventory management (CRIM) subsystem 202, such as the CRIM subsystem 112 depicted in FIG. 1, according to certain embodiments. The CRIM subsystem 202 described herein is configured with capabilities to provide near real-time visibility into its users' cloud resources that are deployed across multiple regions and tenancies within a cloud environment (e.g., a CSPI 212). As previously described, each region within a CSPI may maintain a comprehensive list of all the cloud resources (e.g., virtual machines, databases, storage buckets and so on) that are deployed and actively running for its users across one or more tenancies and one or more regions within the CSPI. A tenancy (i.e., an account) may refer to a logical, isolated partition within a cloud region where a user can create, organize, and manage their cloud resources. A tenancy provides a secure space for the user's applications and data within the region.

In the embodiment depicted in FIG. 2, the cloud resources are spread across two different cloud regions, region-1 (204) and region-2 (206) within the CSPI 212. In certain examples, and as previously described, the cloud resources within each region may be managed by different cloud services within the CSPI. Each cloud service may be responsible for providing a single and trusted source for cloud resource metadata related to cloud resources managed by the cloud service. For instance, the cloud resources in region 204 may be managed by a set of cloud services that may include compute services, block storage services, Virtual Cloud Network (VCN) services, database services (DBaaS) and so on. Likewise, the cloud resources in region 206 may be managed by a similar or a different set of cloud services. Although only two regions are depicted in the example of FIG. 2, in general, the CRIM subsystem 202 may be configured to concurrently obtain cloud resource metadata from any number of cloud regions and any number of cloud services managed by the CSPI.

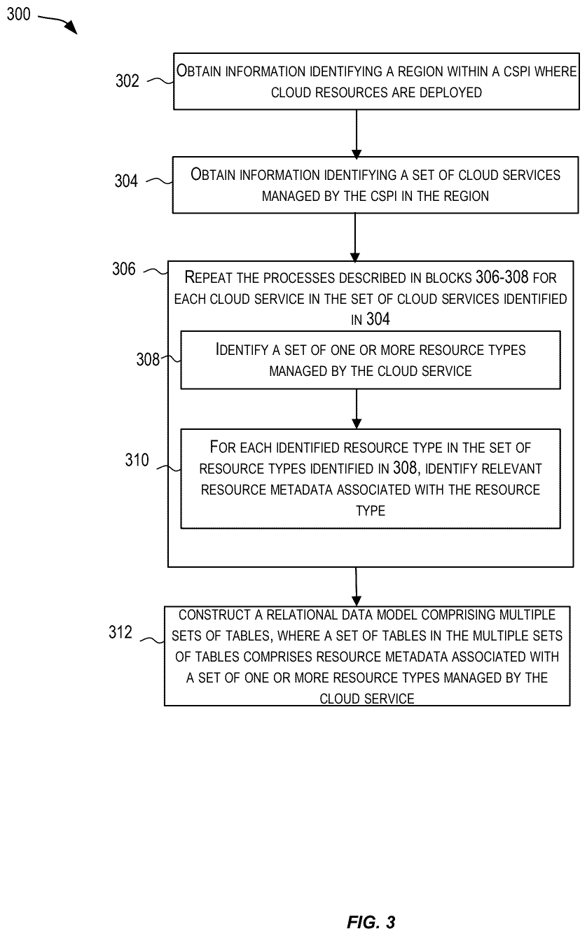

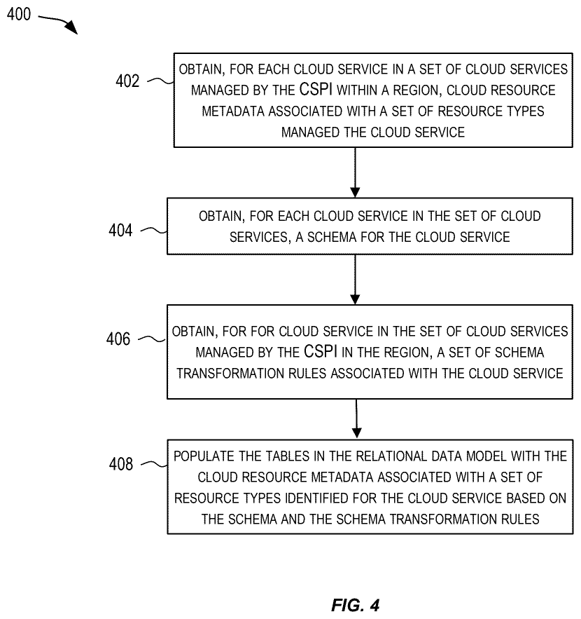

The processing performed by the CRIM subsystem 202 to provide near real-time visibility into its users' cloud resources may occur in two phases. In a first phase, the CRIM subsystem 202 creates a centralized resource inventory (i.e., a single trusted source of cloud resource inventory metadata) to store cloud resource metadata related to all its users' cloud resources that are deployed across different tenancies and regions within the CSPI. The centralized resource inventory provides near real-time visibility for users into their cloud resources deployed across different regions and tenancies within the CSPI. FIG. 3 describes a process used by the CRIM subsystem 202 for creating a centralized resource inventory of cloud resources. In a second phase, the CRIM subsystem 202 obtains cloud resource metadata related to its users in near real-time, processes the cloud resource metadata and populates the processed cloud resource metadata into the centralized resource inventory. FIG. 4 describes a process used by the CRIM subsystem 202 for processing cloud resource metadata and populating the processed cloud resource metadata into a centralized resource inventory.

According to examples described herein, the CRIM subsystem 202 may be configured to obtain and process cloud resource metadata deployed in the CSPI in near real-time. Near real-time refers to a process by which the CRIM subsystem 202 can be configured to obtain cloud resource metadata with a small delay, that can range from a few seconds to a few minutes. For instance, the CRIM subsystem 202 can be configured to automatically pull cloud resource metadata from different regions within the CSPI at periodic time intervals (e.g., once every 30 seconds, or once every minute, or based on other detected events or conditions). The periodicity at which the CRIM subsystem 202 can obtain cloud resource metadata can be pre-configured by an administrator of the RAS 108 or be pre-configured by the CRIM subsystem itself. In certain cases, the CRIM subsystem 202 can be configured to automatically pull cloud resource metadata after an event or observation occurs. An event may represent, for instance, a notification that signals a modification to a resource or a modification to a resource configuration for a resource within the CSPI. Examples of events may include, but are not limited to, a create, read, update, or delete (CRUD) operation performed on a resource such as creating a new virtual machine, updating a database record, or uploading a resource to a cloud service within the CSPI.

FIG. 3 is a flowchart illustrating an example process 300 used by the CRIM subsystem 202 described in FIG. 2 for creating a single, centralized, and trusted cloud resource inventory of cloud resources, according to certain examples. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order or some steps may also be performed in parallel. In certain embodiments, the CRIM subsystem 202 may perform the processing described in blocks 302-312 for multiple geographical areas (regions) managed by a CSPI.

At block 302, the CRIM subsystem 202 obtains information identifying a region (e.g., 204) within the CSPI where cloud resources for its users are actively running and deployed. For instance, information identifying a region may include a region identifier that is a code or name that designates a specific geographical area where the CSPI has established data centers and infrastructure to offer its cloud resources and cloud services.

At block 304, the CRIM subsystem 202 obtains information identifying a set of cloud services managed by the CSPI in the region identified in block 302. As previously indicated, each cloud service may be responsible for providing a single, trusted source for cloud resource metadata related to cloud resources managed by the cloud service. For instance, the cloud resources in a region (e.g., 204 as shown in FIG. 2) may be managed by a set of cloud services that may include, for instance, compute services, block storage services, Virtual Cloud Network (VCN) services, database services (DBaaS), and so on.

At block 306, the CRIM subsystem 202 performs the processing described in blocks 308-310 for each cloud service in the set of cloud services identified in block 304. For instance, at block 308, the CRIM subsystem 202 identifies a set of one or more resource types managed by the cloud service. For instance, for a “Virtual Cloud Service (VCN)” service, the types of resources managed by the service may include, but are not limited to, subnets, route tables, security lists, gateways (internet, service, and NAT), and virtual network interface cards (VNICs). The type of resources managed by a “database service” may include CPU and memory resources, storage resources (for storing data), network resources (for connectivity), security resources (for access control and encryption), and database-specific resources (like schemas, tables, and indexes) and so on. At block 310, for each identified resource type from the set of one or more resource types, the CRIM subsystem 202 identifies relevant metadata (key attributes and relationships) associated with the resource type such a resource identifier, a status, tags, associated services, and dependencies of the resource type.

At block 312, the CRIM subsystem 202 constructs (creates) a centralized resource inventory of cloud resources for the region where cloud resources for its users are deployed. In a certain implementation, the centralized resource inventory may be implemented as a relational data model comprising multiple sets of tables. Each set of tables may be configured to store, for a particular cloud service managed by the CSPI within a particular region, cloud resource metadata managed by the cloud service. For instance, as part of the processing performed in block 312, the CRIM subsystem 202 may create, for each cloud service in the set of cloud services, a set of one or more tables for the cloud service. Each table in the set of one or more tables may represent a resource type of a set of one or more resource types managed by the cloud service. Each column within a table may be configured to store resource metadata for the identified resource type. For instance, in the embodiment depicted in FIG. 2, the relational data model 208 comprises a set of tables (212, 214, and 216) that are configured to store cloud resource metadata managed by a set of cloud services within a region 204 in the CSPI. Each table (i.e., 212) is configured to store, for a particular cloud service (e.g., compute service), cloud resource metadata managed by the cloud service. In certain implementations, as part of the processing performed in block 312, the CRIM subsystem 202 may additionally also identify and establish relationships between the tables associated with a cloud service to represent dependencies and associations between the resource types managed by the cloud service.

After creating the centralized resource inventory as described in FIG. 3 above, the CRIM subsystem 202 populates the centralized resource inventory by consolidating the cloud resource metadata related to the cloud resources deployed in the CSPI for its users across different regions and tenancies. FIG. 4 is a flowchart illustrating an example process 400 used by the CRIM subsystem described in FIG. 2 for populating a centralized resource inventory that is configured to store cloud resource metadata related to cloud resources, according to some examples. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order or some steps may also be performed in parallel.

In certain embodiments, the CRIM subsystem 202 may perform the processing described in blocks 402-408 to create different relational data models (e.g., 208, 210) to store cloud resource metadata associated with different regions (e.g., 204, 206) managed by the CSPI. Additionally, for the processing depicted in 402-406 in FIG. 4, it is assumed that the centralized resource inventory is being populated from scratch (e.g., the resource inventory is empty to start out with). In embodiments, where the centralized resource inventory has previously been built, a check may be first made to see if resource metadata for a particular cloud resource already exists in the resource inventory and the resource inventory is updated with the new resource metadata only when the CRIM subsystem 202 a receives an event (notification) that signals that a modification to a resource or a modification to a resource configuration for a resource within the CSPI was made.

At block 402, the CRIM subsystem 202 obtains, for each cloud service in a set of cloud services managed by the CSPI within a region, cloud resource metadata associated with a set of resource types managed by the cloud service. As previously indicated, the CRIM subsystem 202 may be configured to automatically pull cloud resource metadata from a region within the CSPI at periodic time intervals (e.g., once every 30 seconds, or once every minute, or based on other detected events or conditions). For instance, in the embodiment depicted in FIG. 2, the CRIM subsystem 202 may be configured to pull cloud resource metadata associated with set of resource types identified for the cloud services (e.g., compute, block storage, VCN, DBaaS) identified in region 204 of the CSPI 212.

At block 404, the CRIM subsystem 202 obtains, for each cloud service in the set of cloud services, a schema for the cloud service. In certain embodiments, the schema for a cloud service may be provided to the CRIM subsystem 202 by the service itself. The schema (e.g., 218) provides a set of data definitions for cloud resource metadata managed by the service, data definitions for relationships between the cloud resource metadata, and information related to how the cloud resource metadata for the service may be validated. The schema may be used by the CRIM subsystem 202 to ensure consistency, facilitate reliable cloud resource metadata exchange, and enable efficient processing of the cloud resource metadata in the relational data model created by the CRIM subsystem 202. In certain implementations, the schema may be represented using a JSON format, although representations in other formats are also possible in alternate implementations.

At block 406, the CRIM subsystem 202 obtains, for each cloud service in the set of cloud services managed by the CSPI in the region, a set of schema transformation rules 220 associated with the cloud service. The schema transformation rules 220 specify how individual fields or attributes in the cloud service schema can map to corresponding fields in the tables created by the CRIM subsystem 202 in the relational data model. For instance, the schema transformation rules 220 may specify that certain columns/table names need to be renamed, certain columns (fields) in the tables such as timestamp fields that need to be converted into a schema that is compatible with the relational data model and so on. The schema transformation rules may additionally define how relationships between entities in the service schema 218 may be translated into relationships in the schema in the relational data model, including foreign key mappings and cardinality considerations.

At block 408, the CRIM subsystem 202 populates one or more tables in a relational data model (sometimes also referred to herein as a source relational data model) 208 with the cloud resource metadata associated with a set of resource types identified for the cloud service based on the service schema and the schema transformation rules.

The relational data models (e.g., 208, 210) thus created and populated by the CRIM subsystem 202 as described above may then be used by the RAS to provide its users, in near real-time, with a snapshot of the users' cloud resources that are deployed across multiple regions and tenancies within a cloud environment (e.g., a CSPI 212). In certain examples, a snapshot of the user's cloud resources is created by the RAS by extracting user-specific cloud resource metadata from one or more tables within the relational data models (208, 210) and pushing the extracted user-specific cloud resource metadata into one or more corresponding tables in a target relational data model (e.g., 124) provisioned in the new instance of the cloud resource inventory 122. Additional details related to the operations performed by the RAS to create a user-specific cloud resource inventory for a user that provides the user with a snapshot of the user's cloud resources deployed across multiple regions and tenancies within a cloud environment is described in FIG. 5.

### Creation of a User-Specific Cloud Resource Inventory

FIG. 5 is a flowchart illustrating an example process 500 used by the RAS described in FIG. 1 for creating a user-specific cloud resource inventory for a user, according to certain examples. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel.

In certain embodiments, a user data pipeline creation subsystem 118 within the RAS may perform the processing described in blocks 502-506 for each tenancy and for each region in a list of monitored regions associated with the user in the CSPI. As previously indicated, the list of monitored regions may include one or more regions in the CSPI where the user's resources are deployed and actively running. The list of monitored regions may be specified by the user during the provisioning process described in step (1) of FIG. 1.

At block 502, the user data pipeline creation subsystem 118 extracts, using a user data pipeline (e.g., 119) provisioned by the RAS 108 as part of the provisioning process, user-specific cloud resource metadata stored in a source relational data model (e.g., 116) created by the RAS. The user-specific cloud resource metadata may be extracted by the user data pipeline creation subsystem 118 by performing a filtering operation on the cloud resource metadata stored in one or more tables in the source relational data model to filter and obtain cloud resource metadata that is specific to the user from a list of monitored regions specified by the user. As previously described, the user data pipeline (e.g., 119) may act as an intermediary entity in the RAS that is used for extracting user-specific cloud resource metadata from the source relational data model 116.

At block 504, the user data pipeline creation subsystem 118 transforms (i.e., modifies) the user-specific cloud resource data extracted by the user data pipeline 119 from one or more tables in the source relational data model 116 to fit the data into a specific format or structure of one or corresponding tables in the target relational data model 124. The user data pipeline may be configured with capabilities to make the resource inventory metadata queryable by adding tags (key-value pairs) to each resource. Once tags are applied to each resource, the tags can be used to query, filter, and organize the resources based on metadata associated with the resources, facilitating resource management.

At block 504, the user data pipeline creation subsystem 118 merges the transformed user-specific cloud resource data in the user data pipeline 119 into the specific format or structure of the one or more corresponding tables in the target relational data model 124. Once the target relational data model 124 is populated with user-specific cloud resource metadata, a user 102 of the RAS 108 can connect to the user-specific cloud resource inventory provisioned in the user's tenancy 120 via the console UI 105 to obtain an up-to-date and near real-time view of the user's cloud resource inventory (i.e., hardware and software resources, attributes, relationships, and resource configuration history) across the different regions and tenancies within a CSPI.

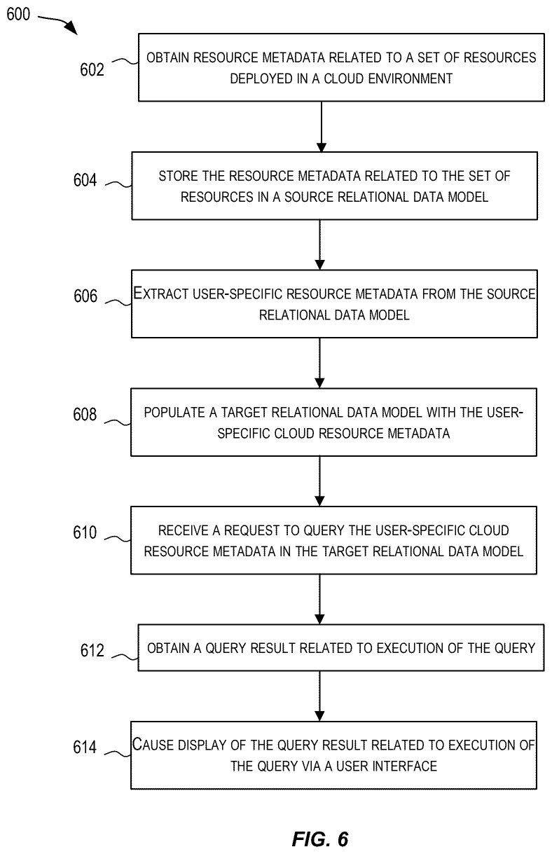

FIG. 6 is a flowchart illustrating an example process 600 used by RAS shown in FIG. 1 for providing near-real time visibility into users' cloud resources that may be deployed and actively running across different geographical areas (regions) within a cloud environment, according to certain examples. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order or some steps may also be performed in parallel. In certain embodiments, RAS may perform the processing described in blocks 602-610 for multiple geographical areas (regions) managed by a CSPI.

At block 602, the RAS obtains resource metadata related to resources deployed in a cloud environment. As previously described, the RAS may be configured to automatically pull cloud resource metadata from a region in the cloud environment (e.g., a CSPI) at periodic time intervals (e.g., once every 30 seconds, or once every minute, or based on other detected events or conditions). In certain embodiments, as part of the processing performed in block 602 the RAS may be configured to obtain, for each cloud service in a set of cloud services managed by the CSPI within a region, cloud resource metadata associated with a set of resource types managed by the cloud service.

At block 604, the RAS stores the resource metadata related to the plurality of resources in a source relational data model. As previously described, as part of the processing performed in block 604, the RAS may populate one or more tables in the source relational data model (e.g., 208) with cloud resource metadata associated with a set of resource types identified for each cloud service based on a service schema and schema transformation rules associated with the service.

At block 606, the RAS extracts user-specific resource metadata from the source relational data model. As previously described, the user-specific cloud resource metadata may be extracted by a user data pipeline creation subsystem (e.g., 118) in the RAS by performing a filtering operation on the cloud resource metadata stored in one or more tables in the source relational data model to filter and obtain cloud resource metadata that is specific to the user from a list of monitored regions specified by the user. The list of monitored regions may include one or more regions in the CSPI where the user's resources are deployed and actively running and where the user wishes to ingest cloud resources from.

At block 608, the RAS populates a target relational data model with the user-specific cloud resource metadata, wherein the target relational data model is created in a user tenancy associated with the user. As part of the processing performed in block 608, the user data pipeline creation subsystem may merge the transformed user-specific cloud resource data in a user data pipeline (e.g., 119) into the specific format or structure of the one or more corresponding tables in the target relational data model 124.

At block 610, the RAS receives a request to query the user-specific cloud resource metadata in the target relational data model. As previously described, the target relational data model may be provisioned by the RAS in a new instance of the cloud resource inventory (e.g., 122) created in a user tenancy associated with the user. As an example, a user can submit a single query such as “Find all running instances across all regions that have a public IP address and unencrypted storage volumes” to the target relational data model.

At block 612, the RAS obtains a query result related to execution of the query. In certain implementations, the query may be constructed by the user using the Structured Query Language (SQL). An example of an SQL query that may be submitted by the user of the RAS described herein is shown in Example-1 above.

At block 614, the RAS causes display of the query result related to execution of the query via a user interface of the resource analytics system. For instance, the user 102 may view the query result via the console UI (e.g., 107) using built-in dashboards and reports 134 provided by an AV model (e.g., 126) that is provisioned as part of the new instance of the cloud resource inventory in the user tenancy associated with the user.

The disclosed cloud resource inventory management technique simplifies cloud resource management by providing users with near real-time visibility into their cloud resource inventory deployed across multiple tenancies and regions of a cloud environment. The disclosed technique eliminates the need for a user to manually gather data through individual API calls, by creating a single, trusted source of resource inventory data. The single, trusted source of inventory data provides the user with enhanced and near real-time visibility into the customer's resource infrastructure and resource relationships through a relational data model that the customer is able easily query in near-real time. For instance, using the techniques described herein, a customer need only submit a single query to the relational data model to obtain a query result. The disclosed technique additionally provides the customer with a seamless and consistent single pane of view of their cloud resources in near real-time and dramatically reduces the computational overhead of calling multiple APIs to obtain relevant information.

Subscriber-Listener RAS Architecture for Providing Near-Real Time Visibility into Cloud Resources Deployed in a Cloud Environment

In certain embodiments, and as previously described, the RAS 108 may be configured to obtain and process cloud resource metadata deployed in a CSPI in near real-time. For instance, the RAS 108 can be configured to automatically pull cloud resource metadata from different regions within the CSPI at periodic time intervals (e.g., once every 30 seconds, or once every minute, or based on other detected events or conditions). In certain instances, the RAS 108 can be configured to automatically pull cloud resource metadata after an event or observation occurs. An event may represent, for instance, a notification that signals a modification to a resource or a modification to a resource configuration for a resource in the CSPI. Examples of events may include, but are not limited to, a create, read, update, or delete (CRUD) operation performed on a resource such as creating a new virtual machine, updating a database record, or uploading a resource to a cloud service within the CSPI. In certain implementations, one or more data plane components within the RAS 108 may be responsible for automatically pulling cloud resource metadata from different regions within the CSPI at periodic time intervals. The data plane components may comprise listeners and subscribers that are configured to deliver selected, authorized, accurate, timely, and current resource metadata, across tenancies and regions, that can be queried by different customers of the RAS.

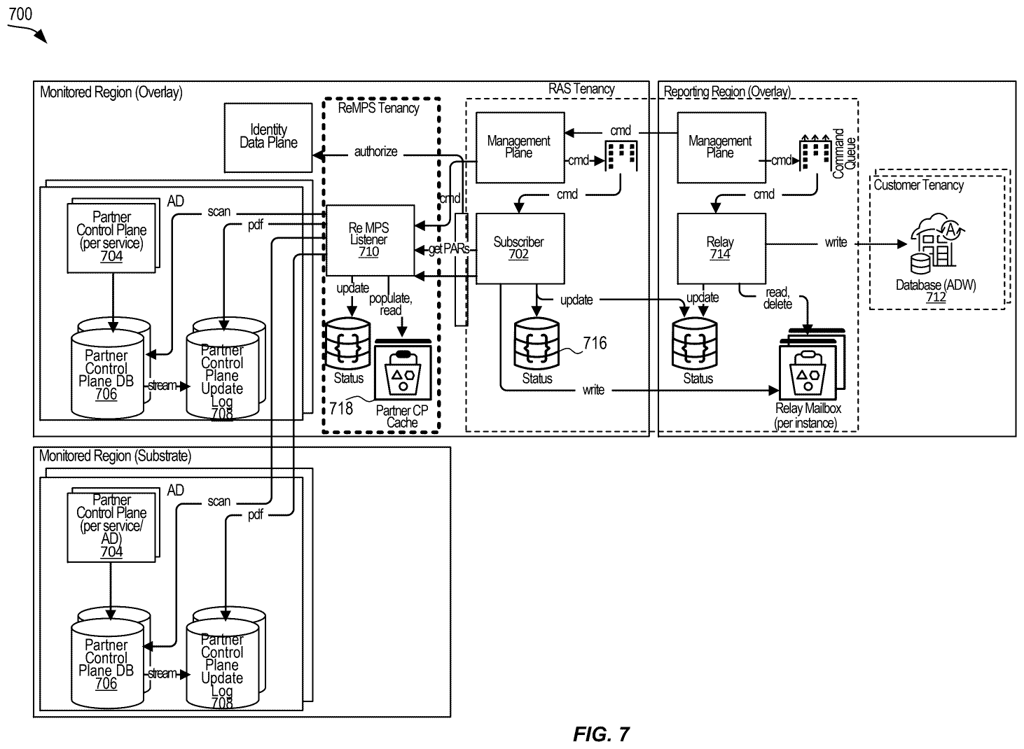

FIG. 7 illustrates an example of interactions between one or more data components in the RAS to provide near real-time cloud resource metadata related to cloud resources deployed across different tenancies and regions in a cloud environment, according to certain examples. In certain examples, the data plane components may include subscribers and listeners that enable the communication and processing of events. A subscriber (also referred to as an event consumer) may represent an application, service, or device, that registers its interest in receiving information about specific events or types of events from a message queue. A listener is a component that can actively “listen” or poll for incoming events or changes. Once an event of interest is detected, the listener receives the message and initiates the associated processing or actions.

In the embodiment depicted in FIG. 7, a subscriber 702 in a particular region in the RAS tenancy may be aware that a customer is onboard when the customer subscribes to the services of the RAS. A partner control plane (e.g., compute CP) 704 in the particular region in the RAS tenancy may receive a request that the customer intends to make a change (e.g., create a new RA instance). This request may be recorded in the partner CP's database 706 and streamed to a partner CP's update log 708. In certain embodiments, the partner CP service 704 in the particular region may be in substrate or overlay. The substrate (or underlay) refers to the physical network infrastructure that provides the underlying connectivity and resources in the cloud environment. The overlay is a virtual network built on top of the underlay, providing logical network connectivity and services. A resource metadata platform service (ReMPS) listener 710 in the particular region, which the subscriber informs about the customer's onboarding, may poll (e.g., every 30 seconds) the partner service CP's update log 708 for any change event. The ReMPS listener 710 polls and scans the log 708 of the different services to see what has changed over a particular time period (e.g., last 30 seconds). This information is written to local database/cache 718 of ReMPS. If the customer has multiple tenancies, the ReMPS listener 710 may poll (or listen) to those tenancies. The ReMPS may additionally listen to all tenancies, and not just limited to the tenancies the subscriber is aware of. The subscriber 702 may record such change events in its status database, and push the metadata collected by the ReMPS listener 710 to a central/global region designated by the customer by performing a cross-region copy operation. The central region may be the region (reporting region) where the customer chooses to have its central inventory database 712 for query purposes that can aggregate information in the customer tenancies across different regions. A relay 714 in the central region where the customer instance of the central inventory database 712 is located may forward the collected metadata to the customer's central inventory database instance. In certain examples, the central inventory database instance may be implemented in a similar manner in which the cloud resource inventory instance (e.g., 122) described in FIG. 1 is implemented.

In certain embodiments, the listener components may be configured to execute transformations that convert the raw event into transformed metadata, synchronously inform (using in-process communication) the subscriber 702, and asynchronously cache the transformed metadata in object storage in batches, regardless of whether it belongs to a tenancy being watched by the central inventory database instance. Then the subscriber pushes the event (on a ˜10 second cadence that batches events) to a region-local object storage bucket. The RAS data plane (synchronizer component), running in a separate process from the listener/transformer/subscriber, pushes the event batch to a per-customer (in service tenancy) object storage bucket. The relay component 714 in the data plane polls its object storage-generated event stream 716, notices the new changes, and updates the corresponding table(s) in the customer's target relational database 712.

A subscriber 702 may make individual API calls for individual customers to the listener 710 to obtain changed data for the customers. The frequency at which the listener polls the databases and the frequency at which the subscriber makes API calls to the listener are independent. For efficiency purposes and to ensure that the subscriber gets the updates as soon as possible, the two frequencies may be the same or close to each other. In this manner, as soon as the listener knows of a change, the subscriber calls the listener to learn about the update. To avoid the multiple API calls and to avoid a no operation, in certain embodiments, an optimization is used. The listener sends to the subscriber, in response to an API called by the subscriber “limited information” for all the customers that the subscriber can use to determine for which customers information has changed. In certain embodiments, a bloom filter is used. The bloom filter conveys information to the subscriber, about customers for which there may be new data available and about customer for which no new data is available. For example, a set of bits may be communicated, where each bit corresponds to a particular customer, and the bit is set to 0 if for sure there is no new data in the polled time period (e.g., the last 30 seconds) and is set to 1 when there may be a change for the corresponding customer. The subscriber uses this information to determine which specific customers to make API calls for to the listener to request data for those customers.

In certain examples, the central inventory database 712 for a customer typically sits in one of the multiple regions in a realm. For each customer for which new updated data is received, the region where that customer's central inventory database sits for that data is identified. The subscriber (one or more if more than one subscriber gets data for that customer for the time period) then forwards the data received from the listener to the relay 714 in that region. In this manner, a relay in a region could get data for the same customer from subscribers in one or more regions. The relay then connects to the customer's central inventory database and writes the data to that central inventory database. In certain examples, a customer may have more than instance of the central inventory database in a customer's reporting region. For example, in a situation where data cannot leave a particular region. A customer could have one central inventory database instance just for resources in Europe and another for resources in the other regions. Each central inventory database instance may be associated with one or more monitored regions. For instance, a service (e.g., Compute service) can have their own databases in the different regions, with each database storing information regarding resources associated with the service in that region.

### Example Cloud Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

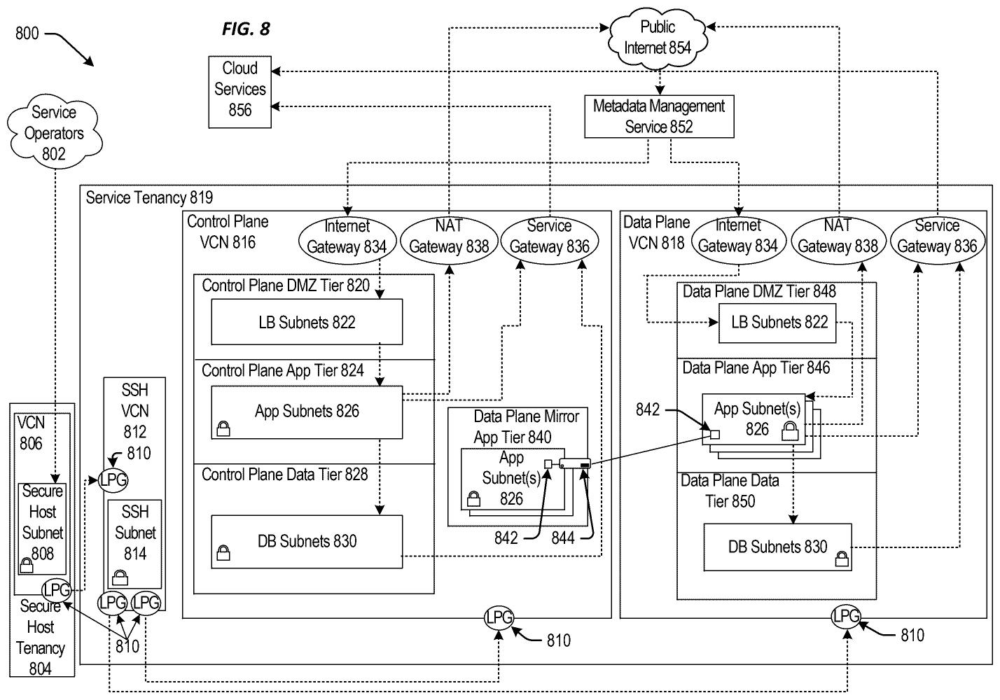

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

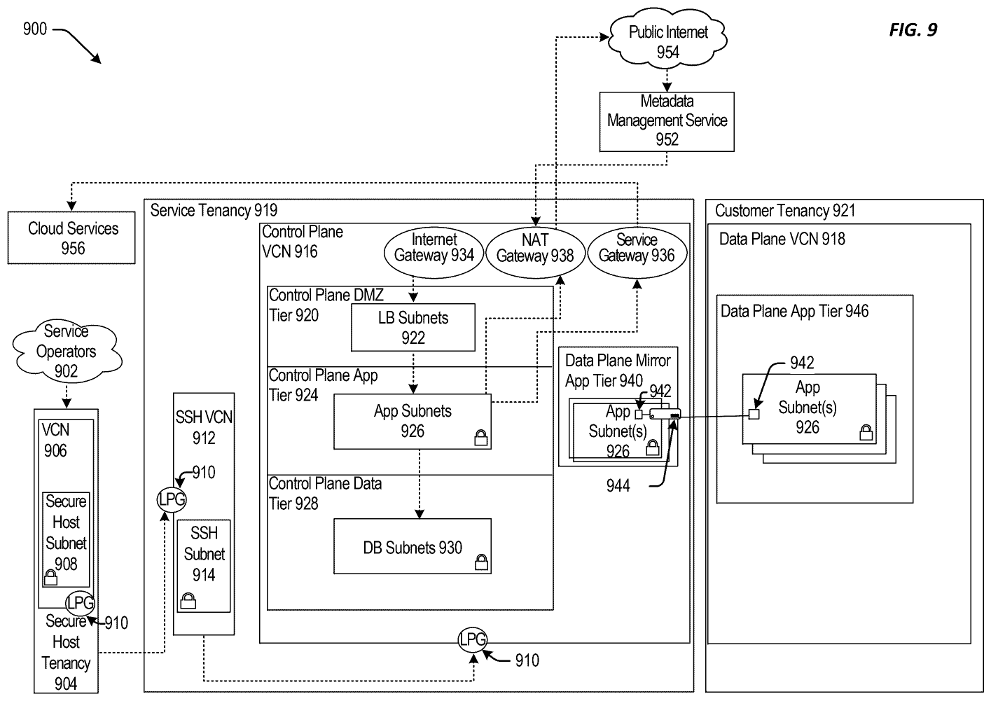

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

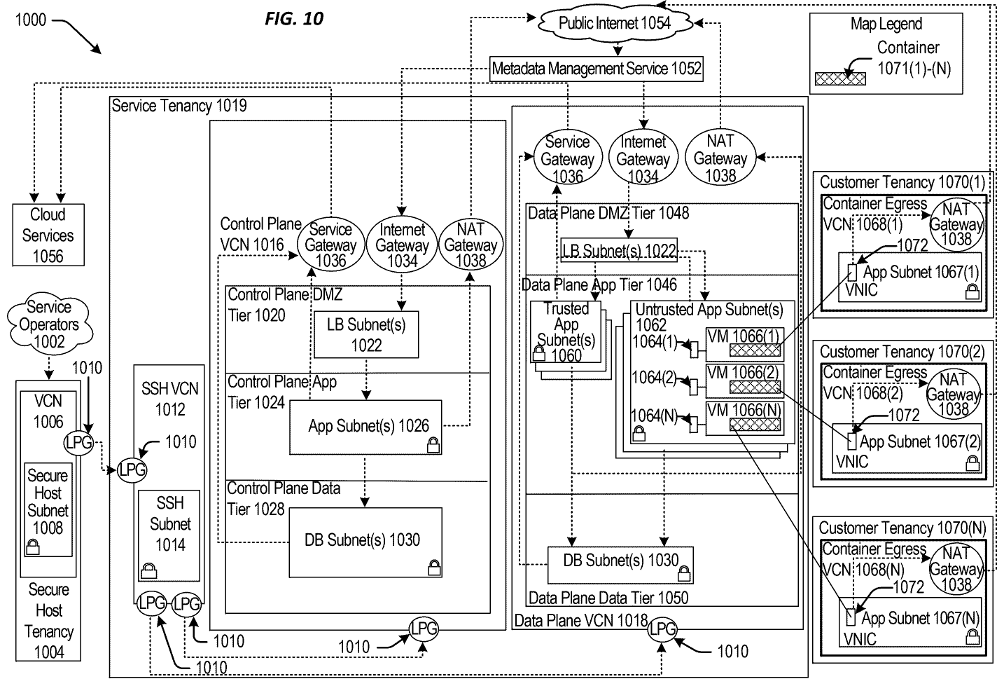

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

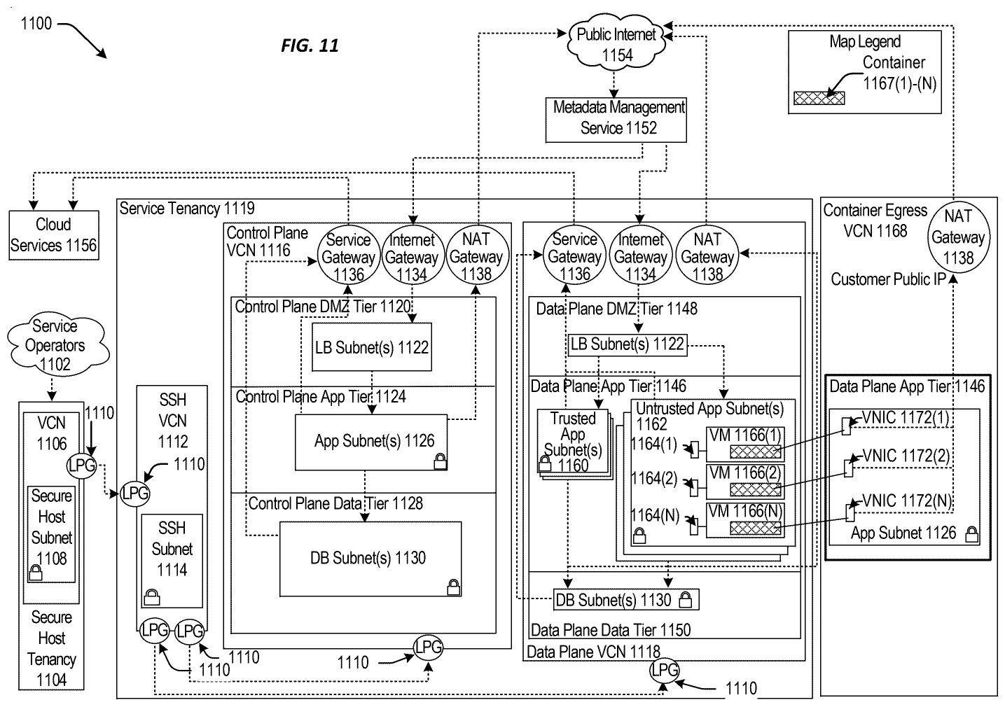

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

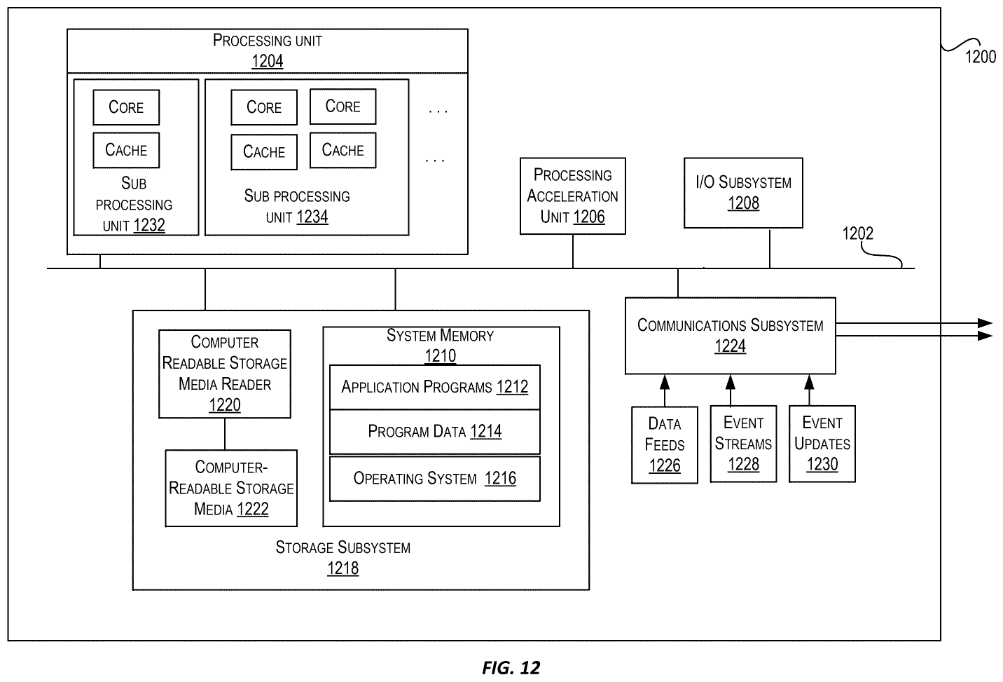

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present disclosure.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
obtaining, by a resource analytics system, resource metadata related to a plurality of resources deployed in a cloud environment;
providing, by the resource analytics system, the resource metadata related to the plurality of resources in a source data model;
extracting, by the resource analytics system, user-specific resource metadata from the source data model;
populating, by the resource analytics system, a target data model with the user-specific resource metadata, wherein the target data model is created in a user tenancy associated with a user;
receiving, by the resource analytics system, a request to query the user-specific resource metadata in the target data model;
obtaining, from the resource analytics system, a query result related to execution of the query; and
causing display, in the resource analytics system, of the query result related to execution of the query via a user interface of the resource analytics system.

2. The computer-implemented method of claim 1, wherein the source data model is a source relational data model comprising a plurality of tables, wherein a first set of tables in the plurality of tables comprises resource metadata related to a first set of resources from the plurality of resources, and wherein the first set of resources are associated with a first cloud service in a plurality of cloud services identified in a region of the cloud environment.

3. The computer-implemented method of claim 2, wherein a second set of tables in the plurality of tables in the source relational data model comprises resource metadata related to a second set of resources from the plurality of resources, wherein the second set of resources are associated with a second cloud service in the plurality of cloud services identified in the region of the cloud environment, and wherein the first cloud service is different from the second cloud service.

4. The computer-implemented method of claim 1, wherein the target data model is a target relational data model comprising a plurality of tables, and wherein populating the target relational data model with the user-specific resource metadata comprises merging the user-specific resource metadata into one or more tables in the plurality of tables in the target relational data model.

5. The computer-implemented method of claim 1, wherein providing the resource metadata related to the plurality of resources in the source data model comprises:
identifying a plurality of cloud services associated with the plurality of resources in a region of the cloud environment;
for each cloud service in the plurality of cloud services, identifying a set of resource types managed by the cloud service; and
for each cloud service in the plurality of cloud services, obtaining cloud resource metadata associated with the set of resource types managed by the cloud service.

6. The computer-implemented method of claim 5, wherein providing the resource metadata related to the plurality of resources in the source data model further comprises:
obtaining, for each cloud service in the plurality of cloud services, a schema associated with the cloud service;
obtaining, for each cloud service in the plurality of cloud services, a set of schema transformation rules associated with the cloud service; and
populating the source data model with the cloud resource metadata associated with the set of resource types managed by the plurality of cloud services based on the schema associated with each cloud service in the plurality of cloud services and the set of schema transformation rules associated with each cloud service in the plurality of cloud services.

7. The computer-implemented method of claim 6, wherein the set of schema transformation rules comprise mapping information for mapping one or more attributes in the schema associated with each cloud service to corresponding columns in one or more tables in the source data model.

8. The computer-implemented method of claim 1, wherein populating the target data model with the user-specific resource metadata comprises:
merging the user-specific resource metadata for the user into one or more tables in a plurality of tables in the target data model.

9. The computer-implemented method of claim 1 further comprising:
receiving, by the resource analytics system, a request to create a new instance of a cloud resource inventory for the user in the user tenancy; and
provisioning, by the resource analytics system, the new instance of the cloud resource inventory in the user tenancy, wherein provisioning the new instance of the cloud resource inventory in the user tenancy further comprises creating the target data model in the user tenancy.

10. The computer-implemented method of claim 9, wherein provisioning the new instance of the cloud resource inventory comprises provisioning an analytics and visualization model in the user tenancy, wherein the analytics and visualization model is accessible to the user via the user interface of the resource analytics system.

11. The computer-implemented method of claim 10, wherein a first interface element in the user interface enables the user to submit the query and view the query result related to execution of the query.

12. The computer-implemented method of claim 10, wherein a second interface element in the user interface enables the user to view one or more relationships between resource metadata associated with resources in the target data model via one or more resource graphs.

13. The computer-implemented method of claim 1, wherein the resource metadata related to the plurality of resources deployed across the region in the cloud environment is obtained in near real-time.

14. The computer-implemented method of claim 1, further comprising:
obtaining user input that identifies user-specific data associated with the user; and
ingesting the user input into a set of tables in the target data model, wherein the user data resides in a networked computing environment that is outside the user tenancy in which the target relational data model is created for the user.

15. The computer-implemented method of claim 14, further comprising:
receiving a second request to query the user-specific cloud resource metadata 2 stored in the target data model in conjunction with the user data ingested into the set of tables in the target data model;
merging the user-specific cloud resource metadata and the user data to obtain a result related to execution of the second request; and
causing display, in the resource analytics system, of the result related to execution of the second request via the user interface of the resource analytics system.

16. A system comprising:
one or more processors; and
non-transitory computer-readable storage medium storing instructions which, when executed by the one or more processors, cause the system to:
obtain resource metadata related to a plurality of resources deployed in a cloud environment;
provide the resource metadata related to the plurality of resources in a source data model;
extract user-specific resource metadata from the source data model;
populate a target data model with the user-specific resource metadata, wherein the target data model is created in a user tenancy associated with a user;
receive a request to query the user-specific resource metadata in the target data model;
obtain a query result related to execution of the query; and
cause display of the query result related to execution of the query via a user interface of the resource analytics system.

17. The system of claim 16, wherein the source data model is a source relational data model comprising a plurality of tables, wherein a first set of tables in the plurality of tables comprises resource metadata related to a first set of resources from the plurality of resources, and wherein the first set of resources are associated with a first cloud service in a plurality of cloud services identified in a region of the cloud environment.

18. The system of claim 16, wherein the target data model is a target relational data model comprising a plurality of tables, and wherein populating the target relational data model with the user-specific resource metadata comprises merging the user-specific resource metadata into one or more tables in the plurality of tables in the target relational data model.

19. A non-transitory computer-readable medium storing instructions executable by a computer system that, when executed by one or more processors of the computer system, cause the one or more processors to perform operations comprising:
obtaining resource metadata related to a plurality of resources deployed in a cloud environment;
providing the resource metadata related to the plurality of resources in a source data model;
extracting user-specific resource metadata from the source data model;
populating a target data model with the user-specific resource metadata, wherein the target data model is created in a user tenancy associated with a user;
receiving a request to query the user-specific cloud resource metadata in the target data model;
obtaining a query result related to execution of the query; and
causing display of the query result related to execution of the query via a user interface of the resource analytics system.

20. The non-transitory computer-readable medium of claim 19, the resource metadata related to the plurality of resources deployed across the region in the cloud environment is obtained in near real-time.
